(19) United States
(12) Patent Application Publication
(10) Pub. No.: US 2017/0008135 A1
(43) Pub. Date: Jan. 12, 2017

(54) SYSTEMS AND METHODS FOR REFURBISHING A PLUNGER OF A GAS WELL SYSTEM

(71) Applicant: Larry R. Allen, Big Piney, WY (US)

(72) Inventor: Larry R. Allen, Big Piney, WY (US)

(21) Appl. No.: 15/200,763

(22) Filed: Jul. 1, 2016

Related U.S. Application Data
(60) Provisional application No. 62/188,826, filed on Jul. 6, 2015.

(51) Int. Cl. B23P 6/02; B05B 7/22; B05B 7/20; E21B 43/12

(52) U.S. Cl. CPC B23P 6/02; E21B 43/122; B05B 7/224; B05B 7/20

(57) ABSTRACT

The disclosure presents systems and methods for refurbishing an artificial gas lift plunger of a gas well system. According to the embodiments described herein, the systems and methods can remove a portion of a plunger body of a cylindrical artificial gas lift plunger of a gas well system. The removed portion(s) of the plunger body can cause the plunger body to be radially symmetric with a uniform body thickness along the length of the plunger body. Further, body material can be deposited onto the plunger body, substantially adhering to the plunger body and forming an increased thickness of the plunger body. Moreover, body material can be removed from the plunger body to cause a substantially uniform thickness of the plunger body.

### RELATED APPLICATIONS

This application claims the benefit under 35 U.S.C. §119(e) of U.S. Provisional Application No. 62/188,826, filed Jul. 6, 2015, which is hereby incorporated by reference herein in its entirety.

### TECHNICAL FIELD

This disclosure relates to plunger lift systems and methods for refurbishing cylindrical components within gas well systems. More particularly, this disclosure relates to systems and methods for refurbishing cylindrical artificial gas lift plungers.

### BRIEF DESCRIPTION OF THE DRAWINGS

Non-limiting and non-exhaustive embodiments of the disclosure are described herein, including various embodiments of the disclosure with reference to the figures listed below.

FIG. 1 illustrates an artificial gas lift plunger according to one embodiment.

FIG. 2A illustrates a cross section view of an artificial gas lift plunger which is radially non-symmetric with a non-uniform body thickness, according to one embodiment.

FIG. 2B illustrates a cross section view of the artificial gas lift plunger according to the embodiment of FIG. 2A, wherein a portion of the plunger body has been removed.

FIG. 2C illustrates a cross section view of an artificial gas lift plunger, wherein body material has been deposited onto the body of the artificial gas lift plunger, according to one embodiment.

FIG. 2D illustrates a cross section view of the artificial gas lift plunger according to the embodiment of FIG. 2C, wherein a portion of the deposited body material has been removed such that the plunger body is radially symmetric with a uniform body thickness.

### DETAILED DESCRIPTION

Wells are regularly used to harvest oil, natural gas, and other resources from below the surface of the earth. Gas well systems often lose output efficiency over time due to a build-up of liquid within the well system. Certain embodiments of gas well systems may avoid the inefficiencies associated with liquid accumulation by employing an artificial gas lift plunger to de-liquefy the gas well of a gas well system. Artificial gas well plungers are commonly used to carry liquid from the bottom of a gas well to an output of the gas well system. De-liquefying a gas well of a gas well system may facilitate fluid communication between the casing, bore, and/or tubing of a gas well. In some systems, a pressure differential or pressure differential value between a down hole pressure of an artificial gas lift plunger and a surface pressure may provide operational energy to the plunger. Further, embodiments of an artificial gas lift plunger may travel in a substantially vertical direction within a gas well to facilitate fluid flow and achieve a desired flow rate from within the gas well to an output of the gas well system. After sustained use of an artificial gas lift plunger, a body portion of the plunger may begin to distort or erode due to frictional forces, and the plunger may become less efficient in de-liquefying the gas well system.

The body of an artificial gas lift plunger may be worn down in one or more regions of the plunger body as a consequence of the friction forces present on the outer surface of the plunger body. Such frictional forces may be a natural consequence of the sustained motion of the plunger within the gas well. The system and methods disclosed herein relate to refurbishing and repairing misshapen or worn artificial gas lift plungers to remove distortions and/or erosions of the plunger body.

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

The systems and methods for refurbishing an artificial gas lift plunger of a gas well system, disclosed herein, may facilitate and/or enable modification, restoration, or repair of a gas well system plunger that is misshapen, warped, distorted, or otherwise radially non-symmetric with a non-uniform body thickness. The systems and methods disclosed herein may facilitate modifying gas lift plungers such that the plunger body may have a uniform, or approximately uniform, thickness along the length of the plunger.

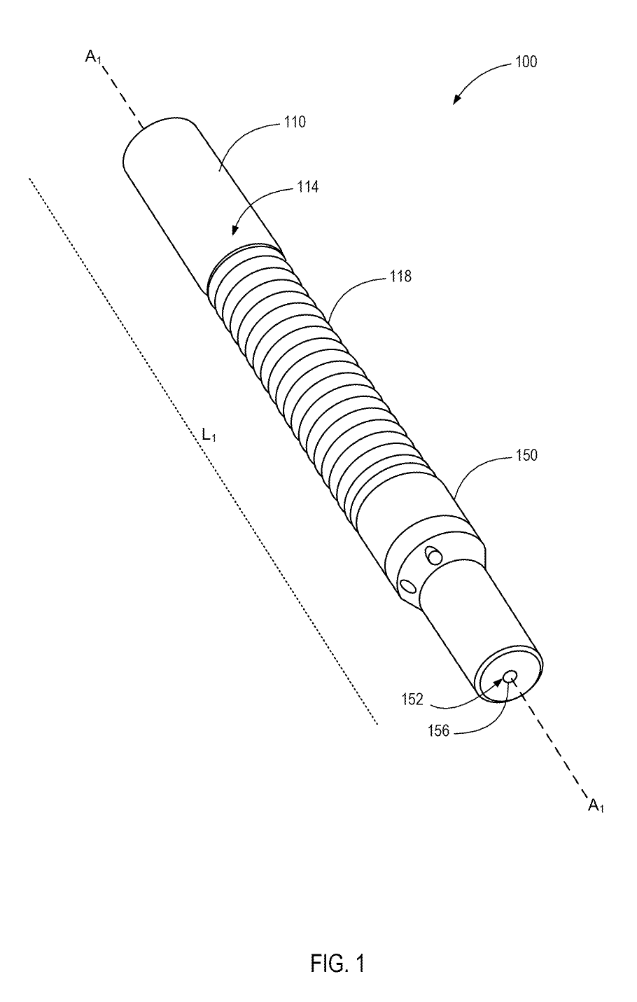

FIG. 1 is a perspective view of an artificial gas lift plunger 100, according to one embodiment. The artificial gas lift plunger 100 may be configured to travel vertically within a gas well casing to facilitate operation of a gas well system. Specifically, the artificial gas lift plunger 100 may travel along a vertical length of a gas well of a gas well system to facilitate fluid communication between the gas well and an output of the gas well system. The artificial gas lift plunger 100 may include a plunger body 110 and a plunger head 150.

The plunger body 110 may be cylindrically shaped and may form one or more features of the artificial gas lift plunger 100. For example, the plunger body 110 may form a first outer surface 114 of the artificial gas lift plunger 100. In some embodiments, the length of an artificial gas lift plunger may vary from the length L₁ of the artificial gas lift plunger 100 shown in FIG. 1. Moreover, some embodiments of an artificial gas lift plunger may further include other features not shown in FIG. 1, such as brushes, bristles, various numbers and styles of rings/fins, one or more extended pads disposed along the length of an artificial gas lift plunger, or other features common to gas lift plungers known to persons having ordinary skill in the art.

In some embodiments, the plunger body 110 may include a plurality of rings 118. The plurality of rings 118 may comprise various materials such as steel, poly materials, Teflon®, stainless steel, etc. The plurality of rings 118 may cover a periphery of the surface of the plunger body 110 in a solid ring sidewall geometry, a shifting ring sidewall geometry, and/or other geometries known to persons having ordinary skill in the art. In other embodiments, a plunger body need not include a plurality of rings, and instead a plurality of rings may be located proximate to the plunger body, and the plurality of rings may be made of a material that is different from the material of the corresponding plunger body.

In some embodiments of an artificial gas lift plunger 100, the plunger head 150 may be formed by the plunger body 110, and may be made from a material that is substantially equal to the material of the plunger body 110. In other embodiments of an artificial gas lift plunger 100, the plunger head 150 may couple with the plunger body 110, such as with threading disposed in the plunger head 150 and corresponding threading disposed in, or defined by, the plunger body 110.

In some embodiments of an artificial gas lift plunger 100, the plunger head 150 may include an aperture 152 defined by the plunger head 150. In some embodiments of an artificial gas lift plunger 100, the aperture 152 defined by the plunger head 150 may couple with a lumen 156 disposed along the length of the artificial gas lift plunger 100. The lumen 156 disposed within an interior of the artificial gas lift plunger 100 may place the aperture 152 defined by the plunger head 150 in fluid communication with a corresponding aperture (not shown) disposed in the back surface of the artificial gas lift plunger 100 opposite the aperture 152 of the plunger head 150.

In some embodiments of an artificial gas lift plunger 100, the artificial gas lift plunger 100 may be disposed within a gas well, and the first outer surface 114 of the plunger body 110 may abut a corresponding shaft wall or inner casing surface of the gas well. In such embodiments, the plunger 100 may be configured to travel vertically within the gas well, and may cause friction forces between the plunger body 110 and the abutting surface of the gas well.

In some embodiments of an artificial gas lift plunger 100, a gas well, and/or a gas well system, the plunger head 150 of the artificial gas lift plunger 100 may come in contact with or abut a portion of a gas well or gas well system. In such embodiments, friction forces may exist between the plunger head 150 and any abutting surface or region that may be in contact with the plunger head 150.

According to various embodiments of an artificial gas lift plunger 100, one or more friction forces between a surface or portion (e.g., the first outer surface 114) of the plunger body 110 and an abutting surface or interface in physical contact with the plunger body 110 may cause some distortion and/or erosion of one or more portions of the plunger body 110. After repeated exposure to such friction forces, one or more regions of the plunger body 110 may become misshapen and/or distorted.

For example, a portion of the cylindrically shaped or rounded outer surface 110 may become flattened. Or, one or more rings of the plurality of rings 118 may become distorted or worn away. In still other scenarios, portions of the plunger head 150 may erode, wear down, or become otherwise damaged.

In some embodiments, a method of implementing the present disclosure may include rotating an artificial gas lift plunger 100 around an axis of rotation A₁ disposed in a center portion of the artificial gas lift plunger 100 and parallel to the length L₁ of the artificial gas lift plunger 100. Further, the method may include removing one or more portions of the plunger body 110 to cause the plunger body 110 to have a uniform cylindrical shape and a uniform thickness. The artificial gas lift plunger 100 may include a second outer surface when one or more portions of the plunger body 110 have been removed.

Some embodiments of the method may include removing one or more portions of the plunger body 110 by placing the artificial gas lift plunger 100 on a lathe, or similar rotational device or system, and cutting portions of the plunger body 110 from the artificial gas lift plunger 100.

Certain embodiments of the method may include depositing at least one body material onto the artificial gas lift plunger 100 to create a deposited portion of the plunger body 110, thereby increasing the thickness of the plunger body 110. In some embodiments, the additional body material may be deposited onto the artificial gas lift plunger 100 by electric arc wire spraying, plasma spraying, detonation spraying, flame spraying, high velocity oxygen fuel coating spraying, and/or other similar thermal spraying techniques disclosed herein.

In some embodiments, the additional body material may be a metal, a metal alloy, or any other body material conducive to adhering to an outer surface of the artificial gas lift plunger 100 by means of a thermal spraying technique.

Rotating the artificial gas lift plunger 100 about the axis of rotation A₁ may facilitate removing any uneven portions of the plunger body 110 to cause the plunger body 110 to have an approximately uniform thickness. Moreover, rotating the plunger 100 about the center axis A₁ may facilitate a substantially uniform deposition of body material onto the plunger 100.

In some embodiments of the method, deposition of body material onto an artificial gas lift plunger 100 that is rotating about the center axis A₁ may be more uniform than a similar deposition of body material onto an artificial gas lift plunger 100 that is not rotating about the center axis A₁.

The artificial gas lift plunger 100 may be rotated during deposition of and/or removal of body material, or at any other point during an embodiment of the method. The rotational velocity of the artificial gas lift plunger 100 about the center axis A₁ may vary based on the thermal spraying technique being utilized and the desired features of the artificial gas lift plunger.

For example, the rotational velocity of an artificial gas lift plunger 100 rotating about the center axis A₁ may be based on several factors, including: the amount of body material to be removed; the size/volume of a portion of body material to be removed; the location of a portion of body material to be removed; the composition of the body material to be removed; the technique by which the body material is being removed; the composition of the body material being deposited; the amount of body material to be deposited; the thermal spraying technique by which the body material is being deposited; the physical dimensions of the artificial gas lift plunger 100; and/or a combination thereof.

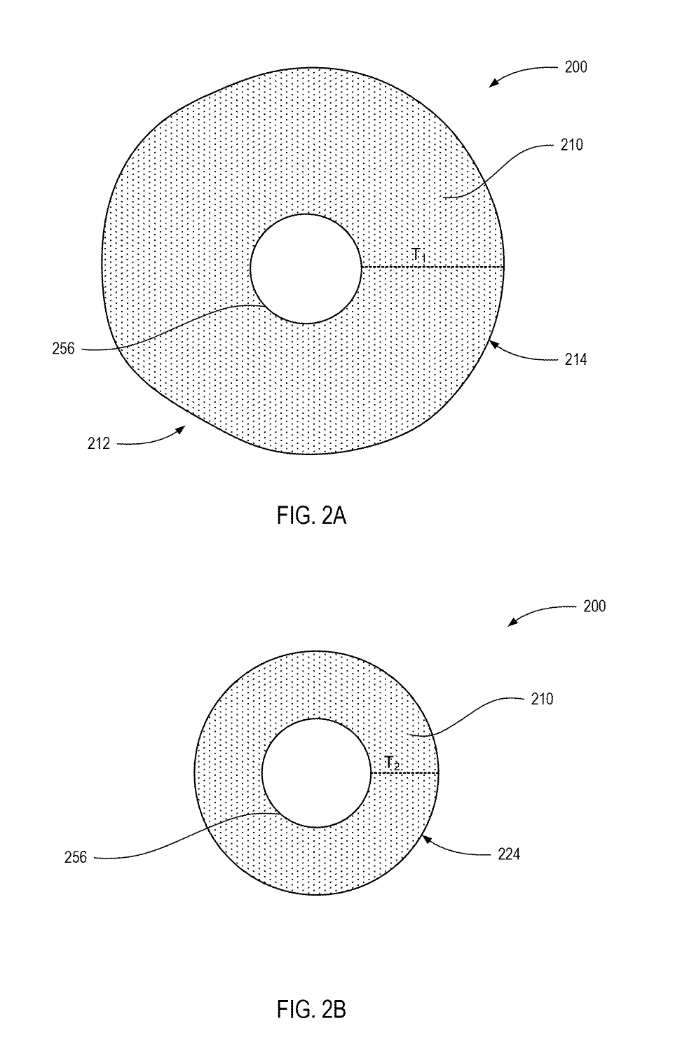

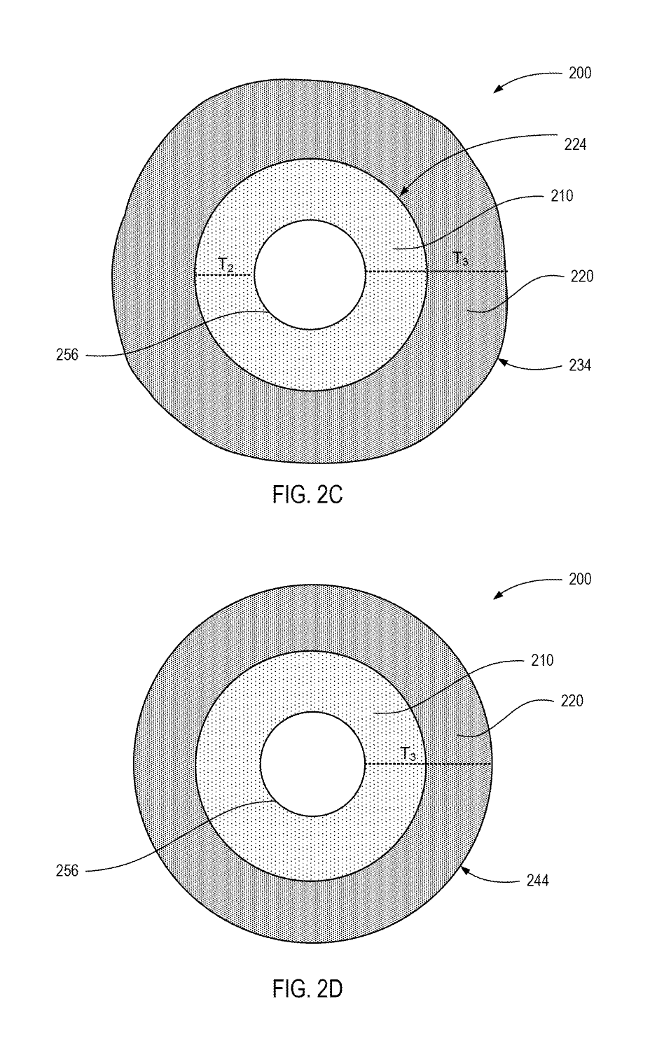

FIG. 2A is a cross section view of an artificial gas lift plunger 200, according to one embodiment. The artificial gas lift plunger 200 includes a plunger body 210 with a non-uniform thickness T₁, being non-uniform as a result of at least one distortion 212 of the plunger body 210 distorting a first outer surface 214 of the plunger body 210.

Some embodiments of an artificial gas lift plunger may include distortion and/or erosion of a plunger body that is greater than or less than the distortions of the plunger body 210 of the artificial gas lift plunger 200 of FIG. 2A. Moreover, the thickness of a plunger body of some embodiments of an artificial gas lift plunger may be greater than or less than the thickness T₁ of the artificial gas lift plunger 200.

FIG. 2B is a cross section view of the artificial gas lift plunger 200, which has had a portion of distorted plunger body removed, according to one embodiment. In some embodiments of the method, one or more portions of the artificial gas lift plunger 200 shown in FIG. 2A may be removed to cause the plunger body 210 of the artificial gas lift plunger 200 to have a uniform thickness T₂ and a substantially cylindrical second outer surface 224 such that the plunger body 210 may be radially symmetric about a lumen 256 of the artificial gas lift plunger 200.

Some embodiments of the method may include removing one or more portions of the plunger body 210 by placing the artificial gas lift plunger 200 on a lathe, or similar rotational device or system, and removing portions of the plunger body 210 from the artificial gas lift plunger 200.

More specifically, some embodiments may include cutting one or more portions of the plunger body 210 with a blade or similar removal tool, which will cut or remove any portion of the plunger body 210 that is disposed a distance equal to or greater than the second thickness T₂ from the outer periphery of the lumen 256 disposed in the center of the artificial gas lift plunger 200. Thus, as one or more portions of the plunger body 210 are removed, the second outer surface 214 and second thickness T₂ of the plunger body 210 may be formed.

Certain embodiments of the method may include various modules, devices, and methods for removing those portions of the plunger body 210 disposed at a distance greater than or equal to the thickness T₂ from the outer periphery of the plunger lumen 256. For example, some embodiments may include a computer aided machining system. Some embodiments may include a laser guided precision machining process or system. Some embodiments may include a precision sanding/smoothing process or system. While some embodiments may include an automatic precision determination device, which may process and remove portions of a plunger body to a determined level of precision.

In some embodiments of the method, after removing one or more portions of the plunger body 210, the second thickness of the plunger body 210 may differ from the second thickness T₂ of the plunger body 210 shown in the embodiment of FIG. 2B. For example, some embodiments may remove a portion of the plunger body 210 to cause the second thickness of the plunger body 210 to be substantially less than or more than the second thickness T₂ of the embodiment of FIG. 2B.

FIG. 2C is a cross section view of the artificial gas lift plunger 200 wherein body material has been deposited onto the plunger body 210 of the artificial gas lift plunger 200 by way of a thermal spraying technique, according to one embodiment.

Some embodiments of the method may include depositing body material onto the plunger body 210. As described herein, one or more portions of the plunger body 210 may have been removed to form a second outer surface 224, and body material may be deposited onto the second outer surface 224. A body material deposited onto the plunger body 210 or the second outer surface 224 may substantially adhere to the plunger body 210 to become part of the artificial gas lift plunger 200 and thereby increase a thickness of the plunger body 210 from the second thickness T₂ to a determined third thickness T₃ that is greater than the second thickness T₂ of the plunger body 210.

The method may include depositing a body material onto the artificial gas lift plunger 200, or onto the first outer surface 214 of the plunger body 210, by thermal spraying body material using one or more of the previously disclosed thermal spraying techniques. In some embodiments, body material may be deposited onto the plunger body 210 without removing any portion of the plunger body 210. In such embodiments, the body material may be deposited onto the first outer surface 214 of the plunger body 210.

In other embodiments, body material may be deposited onto an artificial gas lift plunger 200 with one or more portions of the plunger body 210 removed. In such embodiments, body material may be deposited onto the second outer surface 224 of the plunger body 210, formed after at least one portion of the plunger body 210 is removed.

Some embodiments of the method may include an electric wire arc variation of thermal spraying to deposit body material onto the artificial gas lift plunger 200. In some embodiments, electric wire arc thermal spraying, and equivalent or approximately equivalent deposition processes, may utilize one or more principles employed in many embodiments of a wire arc welding system.

For example, the body material to be deposited onto the artificial gas lift plunger 200 may be fed into an electric wire arc spraying system as at least one wire or filament. The at least one wire or filament may be electrically charged, placed in electrical communication with a power source, injected with an electric current, or otherwise electrically excited according to the operating principles of electric wire arc spraying systems.

Following electrical excitement of the wire or filament of body material, the at least one wire or filament of body material may be placed in electric contact with, or electrically coupled with, one or more elements of the electric wire arc spraying system to cause an electric arc to form between the at least one wire or filament of body material and the coupled component.

The electric arc and/or the electric power traveling through the at least one wire or filament of body material may cause the wire or filament of body material to heat due to the resistive properties of the body material. A sufficient amount of electrical power may be communicated through the at least one wire or filament of body material to cause one or more portions of the at least one wire or filament of body material to substantially melt, forming molten droplets of the body material to be deposited onto the artificial gas lift plunger 200.

The electric wire arc spraying system may then spray the molten droplets of body material onto the artificial gas lift plunger 200. Some embodiments of an electric wire arc spraying system may include a high-velocity air stream that may atomize the molten droplets of body material, and may propel the molten droplets of body material towards the artificial gas lift plunger 200 at a high velocity. The molten droplets of body material may then substantially adhere to the artificial gas lift plunger 200, to increase the thickness of the plunger 210 body, and may form a deposited body portion 220 abutting the second outer surface 224 of the plunger body 210.

In some embodiments of the method, an electric wire arc variation of thermal spraying may enable deposition of body material onto the artificial gas lift plunger without excessive preliminary preparation and may thereby be more cost-effective. In certain embodiments, electric wire arc thermal spraying may be used to apply pure metals and metal alloys such as aluminum, zinc, copper, and/or, stainless steel.

In certain embodiments of the method, an electric wire arc variation of thermal spraying may enable varied textures, or micro-textures, of the deposited body material. For example, in some embodiments, an electric wire arc variation of thermal spraying may enable textures of the deposited body material with sizes between 200 micro inches and 800 micro inches.

Certain embodiments may include an oxygen or acetylene combustion variation of thermal spraying (i.e., flame spraying) to deposit body material onto the artificial gas lift plunger 200. According to various embodiments, an oxygen or acetylene combustion variation of thermal spraying may include one or more features or principles of operation common in many embodiments of a welding torch. For example, it may include melting a body material to be deposited with the head of an oxygen or acetylene combustion reaction, to form molten particles of body material.

Further, some embodiments of oxygen or acetylene combustion variations of thermal spraying may include a high-velocity air stream configured to propel the molten particles of body material onto the artificial gas lift plunger 200. In some embodiments of the method, the body material to be applied may be melted from a wire or filament. In other embodiments of the method, the body material may be melted from a powder or film.

In some embodiments of the method, a layer of body material deposited using oxygen or acetylene combustion variations of thermal spraying may be fused, hardened, and/or cured after being deposited onto the artificial gas lift plunger 200. In such embodiments, a fused, hardened, and/or cured deposition may include enhanced bond strengths and/or may include a greater density of deposited material per cubic unit.

Further, some embodiments may include a plasma spray process, or non-transferred arc process, as a variation of thermal spraying to deposit body material onto the artificial gas lift plunger 200. An embodiment of a plasma spray process variation of thermal spraying may pass one or more inert gases past an electrode that has been electrically excited. As the one or more inert gases pass by the electrically excited electrode, one or more portions of the one or more inert gases may be induced into a plasma state.

Such embodiments may communicate the plasma portion of an inert gas toward an exit nozzle, or an output port, of a plasma spray system. The communicated plasma may exit the nozzle or output port and may return to a normal, inert, and non-plasma or gaseous state. As the plasma transitions into its inert state, a large amount of heat may be produced by the transitioning plasma gas. In some embodiments, a volume of body material to be deposited may be injected into the plasma as a powder as the plasma exits the nozzle of the plasma spray system and transitions from plasma to a gas. The heat produced by the transitioning plasma gas may melt the injected powder of body material into molten droplets and may propel the molten droplets onto the artificial gas lift plunger 200.

In some embodiments of the method, a plasma spray variation of thermal spraying may be used to deposit one or more ceramic body materials. In some embodiments, the high temperatures produced by a plasma spray process may facilitate forming molten droplets of a ceramic body material to be deposited, which may include a high melting temperature (e.g., greater than 3500 degrees Fahrenheit). As described herein, in various embodiments of the method, several types of ceramic body materials may be deposited onto an artificial gas lift plunger, such as chrome or aluminum oxides.

Moreover, certain embodiments of the method may include a High Velocity Oxygen Fuel (HVOF) variation of thermal spraying to deposit body material onto the artificial gas lift plunger 200. An embodiment of an HVOF variation of thermal spraying may include a combustion reaction of oxygen and one or more ignitable gases. For example, an ignitable gas may include propane, propylene, hydrogen, and/or any suitable gas. While many embodiments of an HVOF variation of thermal spraying may include one or more features of a standard combustion variation of thermal spraying described herein, embodiments of an HVOF variation of thermal spraying may include one or more unique features.

For example, an HVOF variation of thermal spraying may include a unique or substantially unique design to produce higher combustion temperatures and may propel molten droplets of body material onto the artificial gas lift plunger 200 at higher velocities than comparable combustion variations of thermal spray. Moreover, the powdered body material may be thoroughly melted to form molten droplets or particles, and a greater amount of kinetic energy may be transferred to each molten droplet of body material.

Molten droplets of body material with large amounts of kinetic energy may flatten or compress as the molten droplets of body material impact the artificial gas lift plunger 200. In many embodiments, the flattened and/or compressed molten droplets of deposited body material may cause increased bond strength of the deposited body material and may produce an increased density of deposited body material per cubic unit. In many embodiments, an HVOF variation of thermal spraying may be used to deposit one or more metals and/or metal alloys with a high melting temperature. For example, deposited metals and metal alloys may include tungsten carbide, Inconle®, chrome carbide, Stellite®, and Tribaloy®.

According to various embodiments described herein, body material deposited by thermal spraying, or any suitable variation of thermal spraying, may include a wide variety of body materials, such as a ceramic, a substantially pure metal, or a metal alloy. For example, deposited materials may include tungsten carbides, stainless steels, ceramics (e.g., chrome oxide, aluminum oxide, Titania), nickel-chrome carbides, aluminum, zinc, and/or copper. However, deposited body material may include any suitable material based on bond strength, melting temperature, rigidity when deposited, and/or any other material property conducive to the methods of the present disclosure.

In some embodiments, the body material deposited onto the second outer surface 224 of the plunger body 210 may form a deposited body portion 220 of the artificial gas lift plunger 200, the deposited body portion 220 forming an uneven third outer surface 234 of the deposited body portion 220. In some embodiments, the third outer surface 234 may include a non-uniform thickness and/or a non-uniform shape. In certain embodiments, the third outer surface 234 may be removed with one or more portions of the deposited body portion 220, to form a more uniform surface and thickness of the deposited body portion 220.

In some embodiments, a portion of, or substantially all of, a body material deposited onto the artificial gas lift plunger 200 may comprise a material that is substantially identical to a material comprising the plunger body 210 of the artificial gas lift plunger 200. Some embodiments may include depositing a portion of body material onto the artificial gas lift plunger 200 that may comprise a material that is not substantially identical to a material comprising the plunger body 210 of the artificial gas lift plunger 200.

Certain embodiments of the method may include depositing a plurality of layers of body material onto the artificial gas lift plunger 200. Each layer of body material deposited onto the artificial gas lift plunger 200 may be deposited according to any variation of the thermal spraying techniques described herein.

For example, some embodiments may include depositing a layer of body material comprising aluminum, utilizing an oxygen combustion variation of thermal spraying, and depositing another layer of body material comprising a ceramic, utilizing an electric wire arc variation of thermal spray. However, any suitable combination of body materials and thermal spraying variations may be used to achieve a desired body material thickness, rigidity, durability, texture, shape, and/or any other significant feature of a plunger body of an artificial gas lift plunger.

FIG. 2D is a cross section view of the artificial gas lift plunger 200 with a portion of the deposited body material removed and the plunger body 210 being radially symmetric with a uniform body thickness T₃, according to one embodiment.

Some embodiments of the method may include removing any non-uniform portions of the deposited body material, similar to the removal of one or more portions of the plunger body 210 described in relation to FIG. 2B. Thus, embodiments of the method may include removing any portion of the deposited body portion 220 of the artificial gas lift plunger 200 that is disposed a distance that is greater than or equal to the third thickness T₃ from the outer periphery of the plunger lumen 256. In such embodiments, the removal of a portion of the deposited body material may cause the substantially uniform third thickness T₃ of the plunger body 210, and may form a fourth outer surface 244 of the plunger body 210.

In some embodiments, the third thickness T₃ of the plunger body may be greater than the second plunger body thickness T₂. In some embodiments, the third thickness T₃ of the plunger body 210 may be less than the first thickness T₁ of the plunger body 210. In other embodiments, the third thickness T₃ of the plunger body 210 may be substantially equal to the first thickness T₁ of the plunger body 210. In yet other embodiments, the third thickness T₃ of the plunger body 210 may be substantially greater than the first thickness T₁ of the plunger body 210. As can be appreciated, some embodiments may include any suitable variation of the first, second, and/or third thicknesses T₁, T₂, T₃ of the plunger body 210.

What is claimed is:

1. A method for refurbishing a plunger of a gas well system, comprising:
removing a portion of a cylindrical plunger of a gas well system to cause a plunger body to be radially symmetric and of uniform first thickness along the length of the plunger body;
depositing body material onto the plunger body, the body material deposited onto the plunger body substantially adhering to the plunger body to form a second body portion and causing a second body thickness of the plunger body, where the second body thickness is greater than the first body thickness; and
removing any non-uniform portions of the deposited body material to cause a substantially uniform third thickness of the plunger body, the third thickness being greater than the first plunger body thickness and less than the second plunger body thickness.

2. The method of claim 1, wherein the plunger is revolved about a longitudinal axis disposed in a center portion and substantially parallel with the length of the plunger to facilitate removing the body material.

3. The method of claim 1, wherein the plunger is revolved about a longitudinal axis disposed in a center portion and substantially parallel with the length of the plunger to facilitate depositing the body material.

4. The method of claim 1, wherein the body material is removed such that rings or fins are created on a periphery of the plunger body.

5. The method of claim 1, wherein the body material is deposited such that rings or fins are created on a periphery of the plunger body.

6. The method of claim 1, wherein the deposited body material is a metal alloy.

7. The method of claim 1, wherein the body material is deposited on the plunger body by thermal spraying the body material upon the plunger body.

8. The method of claim 7, wherein thermal spraying comprises selecting from the group consisting of electric arc wire thermal spraying, plasma thermal spraying, detonation thermal spraying, flame thermal spraying, and high velocity oxygen fuel coating thermal spraying.

9. A method for refurbishing a plunger, comprising:
smoothing a portion of a plunger body to cause the plunger body to be radially symmetric and of uniform thickness along the length of the plunger body;
depositing body material onto the plunger body; and
removing any non-uniform portions of the deposited body material to cause the plunger body to be radially symmetric and of uniform thickness along the length of the plunger body.

10. The method of claim 9, wherein the plunger is revolved about a longitudinal axis disposed in a center portion and substantially parallel with the length of the plunger to facilitate smoothing the body material.

11. The method of claim 9, wherein the plunger is revolved about a longitudinal axis disposed in a center portion and substantially parallel with the length of the plunger to facilitate depositing the body material.

12. The method of claim 9, wherein the body material is smoothed such that rings or fins are created on a periphery of the plunger body.

13. The method of claim 9, wherein the body material is deposited such that rings or fins are created on a periphery of the plunger body.

14. The method of claim 9, wherein the deposited body material is a metal alloy.

15. The method of claim 9, wherein the body material is deposited on the plunger body by thermal spraying the body material upon the plunger body.

16. The method of claim 15, wherein thermal spraying comprises selecting from the group consisting of electric arc wire thermal spraying, plasma thermal spraying, detonation thermal spraying, flame thermal spraying, and high velocity oxygen fuel coating thermal spraying.

17. A method for refurbishing a plunger, comprising:
depositing body material onto a plunger body; and
evening any non-uniform portions of the deposited body material to cause the plunger body to be radially symmetric and of uniform thickness along the length of the plunger body.

18. The method of claim 17, wherein the deposited body material is a metal alloy.

19. The method of claim 17, wherein the body material is deposited on the plunger body by thermal spraying the body material upon the plunger body.

20. The method of claim 19, wherein thermal spraying comprises selecting from the group consisting of electric arc wire thermal spraying, plasma thermal spraying, detonation thermal spraying, flame thermal spraying, and high velocity oxygen fuel coating thermal spraying.
